(19) United States
(12) Patent Application Publication
(10) Pub. No.: US 2023/0401532 A1
(43) Pub. Date: Dec. 14, 2023

(54) STOCK LEVEL DETECTION APPARATUS AND METHODS THEREOF

(71) Applicant: AHOLD DELHAIZE LICENSING SÀRL, Geneva (CH)

(72) Inventors: Mitchell James BERTHELOT, Davidson, NC (US); John NEWTON, Boston, MA (US); Deep Saran MASANAM, Sunderland, MA (US)

(21) Appl. No.: 18/307,959

(22) Filed: Apr. 27, 2023

Related U.S. Application Data
(60) Provisional application No. 63/363,982, filed on May 2, 2022.

(51) Int. Cl. G06Q 10/087; G01S 17/86; G01S 17/89; G01S 7/481

(52) U.S. Cl. CPC G06Q 10/087; G01S 17/86; G01S 17/89; G01S 7/4817

(57) ABSTRACT

An inventory detection system including a sensor module disposed on a first shelf, wherein the first shelf includes a top surface and a bottom surface opposite the top surface, the sensor module includes a distance sensor to measure a distance value to an item at an inventory location on a second shelf located below the first shelf, a linear movement system mounted to the bottom surface of the first shelf, the linear movement system being configured to translate the sensor module along a horizontal direction of the first shelf so as to acquire the measured distance value, and a control unit configured to control the linear movement of the sensor module and collect data associated with the measured distance value. The control unit is configured to determine items remaining on the second shelf based on a comparison of the measured distance value to a distance threshold to define an inventory assessment.

### TECHNICAL FIELD

The present disclosure relates to a stock level detection apparatus. More specifically, the present disclosure is directed to a real-time on-shelf stock detection apparatus.

### BACKGROUND

Typically, stocking processes to determine a level of products on a shelf is a highly manual process that involved store associates physically traversing through all aisles of a store and noting what products are low or out-of-stock. In addition, there is no standardized procedure of indicating the stock level situation on store shelves as each store associate handles the determination of stock level with different techniques.

One approach to resolve the above is to automate the stock level situation and use cameras with a computer vision algorithm to determine when a product is fully out-of-stock. However, this approach requires large amounts of data and high processing power to analyze and generate a prediction to process the data. The other problem is potential privacy concerns with having many cameras spread out across the retail store. Even with proper data security measures in place, the perception of cameras monitoring store activity can lead associates and customers to believe the cameras are there to monitor them. In addition, while camera solutions are capable of determining if a product is in-stock or out-of-stock, they generally cannot provide an amount of stock remaining. That is, existing camera solutions only determine when a certain item is completely unstocked as opposed to when any number of items greater than zero remain on the shelf.

Another option for camera-based systems is to mount cameras to a robot that patrols store aisles. However, additional drawbacks are also associated with this solution, including results that are not real-time or near real-time and still introduces a solution that still visibly interacts with the customers and associates.

Another approach involves sensors placed directly on the shelf. Current designs utilize light sensors, weight sensors, touch sensors, and distance sensors to collect data from the environment. Each of these sensor types can be used in numerous ways to collect real-world information to support different design choices. However, many of these designs present shortcomings, such as: expensive cost, difficult installation, and not enough data resolution to make accurate predictions. Most of these solutions require an array of sensors that are strategically spaced out to capture the data needed to determine an amount and/or percentage of stock remaining per product type. Because so many sensors are needed, the increased cost is not just from a raw material perspective, but also employee time to set up arrays of sensors. In addition, the sensor configuration and placement are highly dependent on the size and shape of the product being sensed. Furthermore, depending on the sensors used, it may only be possible to determine the stock level on a per shelf basis and not on a per item basis.

In view of the problems associated with conventional devices for determining stock level detection, there remains a need to provide a stock level detection apparatus to determine any number of items remaining on a shelf while communicating that information in real-time.

### SUMMARY

In an exemplary embodiment, an inventory detection system includes a sensor module disposed on a first shelf, wherein the first shelf includes a top surface and a bottom surface opposite the top surface, the sensor module includes a distance sensor to measure a distance value to an item at an inventory location on a second shelf located below the first shelf, a linear movement system mounted to the bottom surface of the first shelf, the linear movement system being configured to translate the sensor module along a horizontal direction of the first shelf so as to acquire the measured distance value, and a control unit configured to control the linear movement of the sensor module and collect data associated with the measured distance value. The control unit is configured to determine items remaining on the second shelf based on a comparison of the measured distance value to a distance threshold to define an inventory assessment.

In another exemplary embodiment, a method of assessing inventory in a shelving unit comprises measuring, by a sensor module, a distance value to an item at an inventory location on a first shelf, wherein the sensor module is disposed on a second shelf, which is above the first shelf, translating, via a linear movement system, the sensor module along a horizontal direction of the second shelf so as to acquire the measured distance value, wherein the linear movement system is mounted to a bottom surface of the second shelf, controlling, via a control unit, the linear movement of the sensor module to collect data associated with the measured distance value, and determining, by the control unit, items remaining on the first shelf based on a comparison of the measured distance value to a distance threshold to define an inventory assessment.

Other features and advantages of the present invention will be apparent from the following more detailed description of the preferred embodiment which illustrates, by way of example, the principles of the invention.

### BRIEF DESCRIPTION OF THE DRAWINGS

FIG. 1 is a schematic representation of an exemplary shelving system.

FIG. 2 is a schematic representation of a shelf of the shelving system of FIG. 1, according to an example embodiment of the present disclosure.

FIG. 3A is a partial, bottom view of the shelving system of FIG. 1, according to an example embodiment of the present disclosure.

FIG. 3B is a partial, side view of the shelving system of FIG. 1, according to an example embodiment of the present disclosure.

FIGS. 4A-4C are schematic representations of a distance sensor in various positions, according to an example embodiment of the present disclosure.

FIG. 5 is a schematic representation of a linear movement system, according to an example embodiment of the present disclosure.

FIG. 6A is a schematic representation of a holding device for distance sensors, according to an example embodiment of the present disclosure.

FIG. 6B is a side view of the shelving system and viewing angles of the distance sensors of FIG. 6A, according to an example embodiment of the present disclosure.

FIG. 6C is a schematic representation of a holding device including a connecting mechanism, according to an example embodiment.

FIG. 7 is a schematic representation of a holding device for holding a distance sensor according to another example embodiment of the present disclosure.

FIGS. 8A and 8B are partial, bottom views of the distance sensor on the shelving system, according to an example embodiment of the present disclosure.

FIG. 9 is a side view of the distance sensors mounted to the shelving system, according to an example embodiment of the present disclosure.

FIGS. 10A and 10B are schematic representations of the distance sensors in operation, according to an example embodiment of the present disclosure.

FIG. 11 is a schematic representation of an exemplary inventory management system, according to an example embodiment of the present disclosure.

FIGS. 12A-12D are display representations showing an exemplary output display of an inventory management system, according to an example embodiment of the present disclosure.

FIG. 13 is a flowchart illustrating an exemplary method, according to an example embodiment of the present disclosure.

FIG. 14 is a flowchart illustrating an exemplary method, according to an example embodiment of the present disclosure.

FIG. 15 is a flowchart illustrating an exemplary method, according to an example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION

The present disclosure provides store associates in a retail environment to receive an amount or percentage of the stock remaining of a specific product on a given shelf in real-time. This enables the store associates to respond in a preventive manner as opposed to a reactive manner and allows them to be notified when a product is running low in stock rather than after it has already run out-of-stock. Conventional devices only determine when a certain item is completely unstocked as opposed to when any number of items greater than zero remain.

Exemplary embodiments provide for horizontal/translational movement of a sensor module along the length of a retail shelf. This avoids the need for multiple arrays of sensors mounted on each shelf. Arrays of sensors present numerous challenges that are solved by a design in which the sensors move with respect to the shelf, minimizing the number of sensors per shelf, such as to three or fewer. Exemplary embodiments also can be employed with being reliant on flow racks or gravity fed shelves in order to work. The present disclosure uses a minimal number of sensors at fixed angles or on a rotating mechanism that is compatible with monitoring items on a conventional flat shelf and there is no need for exclusively relying on gravity and/or spring-based shelving systems.

According to some implementations, a Time-of-Flight (ToF) distance sensor(s) is placed on a bottom surface of an upper shelf facing the product below on a lower shelf, and monitoring the stock level in real-time. Using the ToF distance sensor to collect data about the location of items on a shelf provides predictions of stock level on a per product basis. This is made possible by mounting the ToF sensor on a moving component (i.e., a linear movement system) enabling only one sensor to capture the entire state of the shelf in combination with comparing data regarding sensor position along the shelf to planogram information.

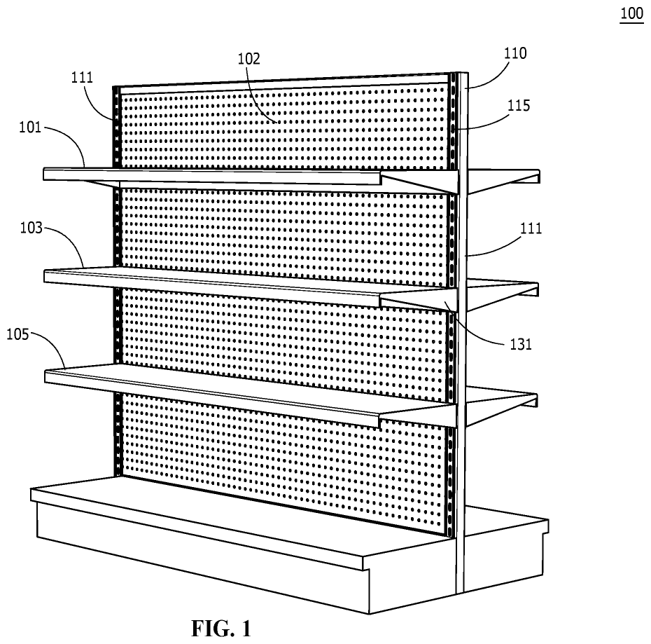

Referring now to the drawings, FIG. 1 illustrates a shelving system 100 having a plurality of shelves 101, 103, 105 attached to a wall 102 of the shelving system 100. While FIG. 1 only shows three shelves, it should be appreciated that there may be more or less than three shelves forming the shelving system 100. To describe differently, shelf 101 can be construed as an upper shelf, shelf 103 can be construed as a middle shelf, and shelf 105 can be construed as a lower shelf. The wall 102 could be any surface upon which the shelves 101, 103, 105 are mounted thereto. For example, the wall 102 can be the wall of the shelving system 100 as shown herein or can be the wall of a building or some other structure where shelves can be mounted. In some implementations, the shelves 101, 103, 105 can be mounted to a shelving bracket 110 that extends vertically at each end 111 of the wall 102, to provide structural support. In some implementations, the wall 102 can be a dual structure where the other side of the wall 102 can also mount additional shelves. That is, shelves can be mounted on either side of the wall 102 to display items on either aisle in a retail store.

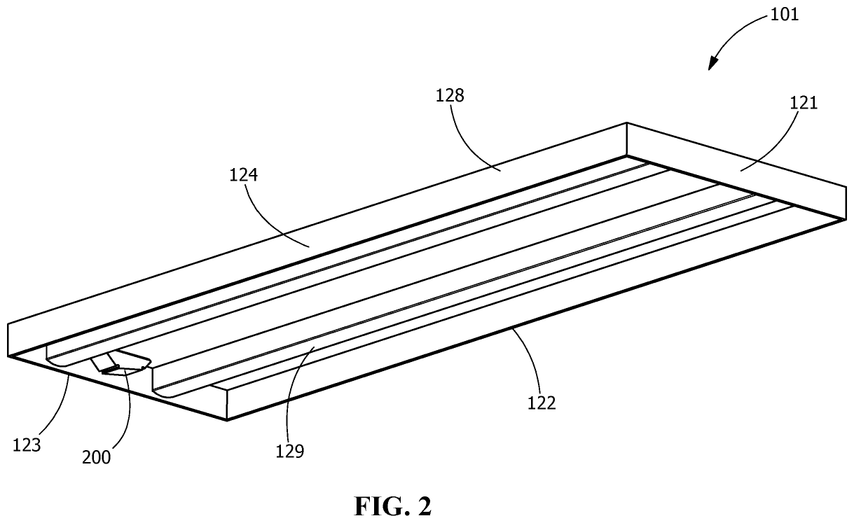

Referring to FIG. 2, each of the shelves 101, 103, 105 is a rectangular, flat shelf having a right side 121 and a left side 123, a back edge 122, a front edge 124, as well as a top surface 128 and a bottom surface 129. As defined herein, the term “horizontal direction” is described as a length of travel from the right side 121 to the left side 123 or vice-versa. The shelves 101, 103, 105 can be mounted to the wall 102 by a shelf hook 131 (FIG. 1), which is positioned at the respective sides (i.e., right side 121 and left side 123). The shelf hook 131 may have protrusions (not shown) that extend out from the back of the shelf hook 131 and are shaped to engage with the shelf bracket 110 of the shelving system 100. In some implementations, the shelving bracket 110 includes a plurality of openings 115 to adjust the placement of the shelves 101, 103, 105 on the shelving bracket 110. This provides proper spacing between the shelves 101, 103, 105 such that various sized items can be placed on the shelves 101, 103, 105.

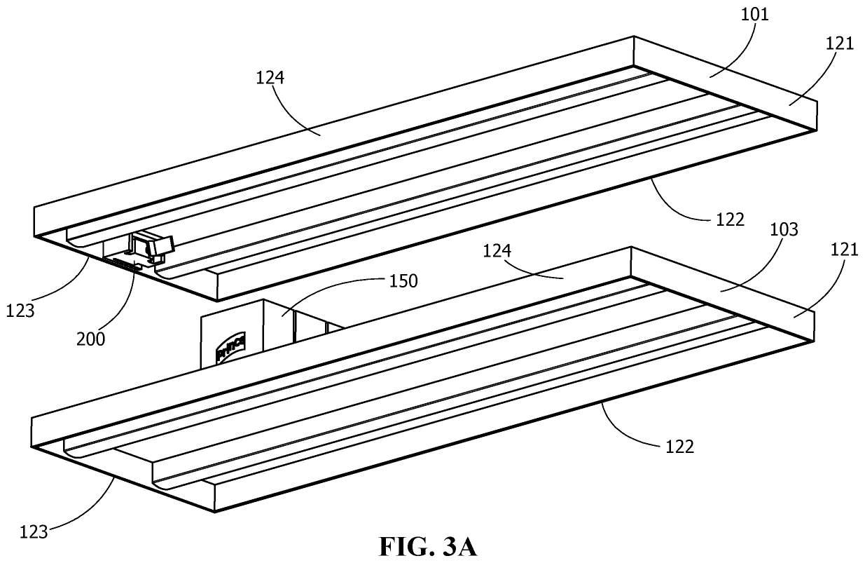

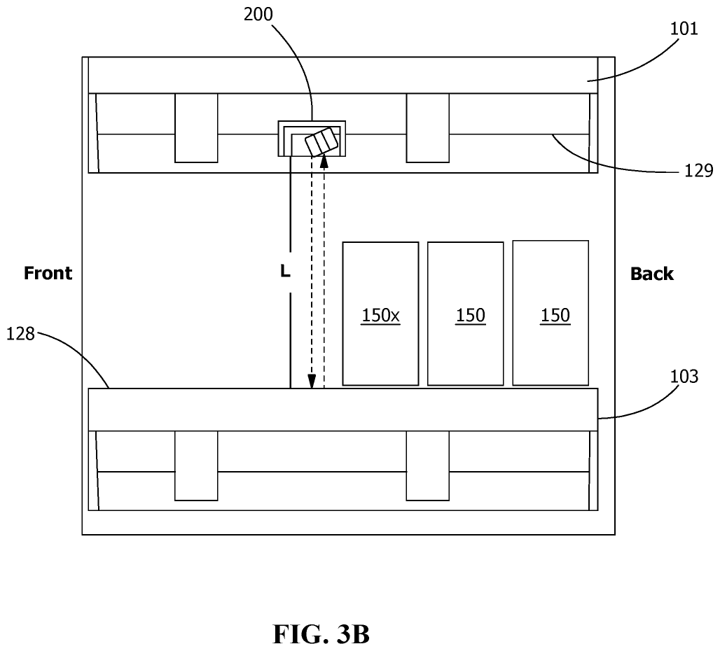

Referring to FIGS. 3A and 3B, the shelving system 100 further includes a distance sensor 200 mounted on the underside of the uppermost shelf 101 to detect a level of stock (i.e., item 150) remaining on the middle shelf 103 positioned immediately below the uppermost shelf 101 (and which could likewise be repeated with the underside of the middle shelf 103 and the lowermost shelf 105 with respect to the three shelf unit illustrated, although it will be appreciated that the same arrangement can be accommodated with any number of any shelves. It should further be appreciated that while FIGS. 3A and 3B depict the distance sensor 200 mounted on only shelf 101, the distance sensor 200 can also be mounted on each of shelves 103 and 105. In one implementation, the distance sensor 200 is mounted at the bottom surface 129 of shelf 101. As such, the distance sensor 200 senses the item 150 arranged below shelf 101. That is, the distance sensor 200 senses the item 150 situated on shelf 103. In some implementations, the distance sensor 200 measures a distance L between the distance from the sensor 200 as positioned on the bottom surface 129 of shelf 101 and the top surface 128 of shelf 103, as shown in FIG. 3B, based on a time difference between an emission of a signal and its return back to the distance sensor 200, after being reflected by the top surface 128. For example, when items 150 are placed on the shelf 103, the measured distance values will be closer to 0, and as the products are removed, the distance values will increase. In other implementations, the distance sensor 200 can measure a distance between the distance sensor 200 and a foremost item 150x on the shelf 103 (i.e., closest to the front), based on a time difference of the emission signal between item 150x and the distance sensor 200. In other words, the distance sensor 200 can measure the distance L to the foremost retail item 150x, and hence a distance will increase when the item 150 is removed from the shelf 103. In this implementation, the measurement is effectuated by measuring a distance to a top portion of the item 150, which can be the foremost item on shelf 103. In other implementations, the distance sensor 200 may measure the distance to some other proximate location, such as, the backwall of the shelf, representative of or correlating to the location of the amount of space occupied by the item 150 at that particular shelf. As defined herein, the measured distance L can include a distance of the distance sensor 200 having a thickness that is part of that measured distance.

The distance sensor 200 may be any device capable of sensing the distance L between the distance sensor 200 and the item 150. In one exemplary embodiment, the distance sensor 200 is a light range sensor having a light transmitter (emitter) and a light receiver (collector). For example, the distance sensor 200 may be a Time-of-Flight (ToF) laser ranging sensor. It should be appreciated that other light source may be employed, such as infrared (IR) or visible light. In other implementations, the distance sensor 200 may be an ultrasonic range sensor, or any other type of range finder or proximity sensor.

In some implementations, the ToF sensor can be a direct or an indirect sensor. Direct ToF sensors send out short pulses of light that last just a few nanoseconds and then measure the time it takes for some of the emitted light to come back. Indirect ToF sensors send out continuous, modulated light and measure the phase of the reflected light to calculate the distance to an object. Some benefits of using ToF sensors are: a) a true distance measurement is obtained independent of the target size, color, and reflectance; b) accurate and high-speed distance measurement; and/or c) low power consumption. In addition, there is no in-field unit calibration required; and can be combined with additional ToF sensors to increase depth scene. Moreover, ToF sensors can be combined with other equipment such as, for example, regular color camera for color overlay.

In some implementations, the distance sensor 200 may have a detection range (i.e., measurement of distance L) of approximately 0.1 m to 1.2 m; a field of view of 15° to 25°; resolution of 1 mm, and a detection rate of at least 90%.

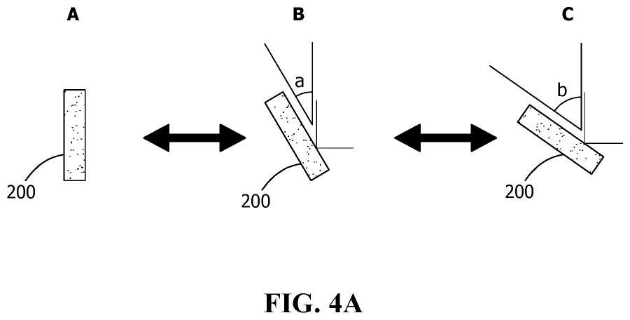

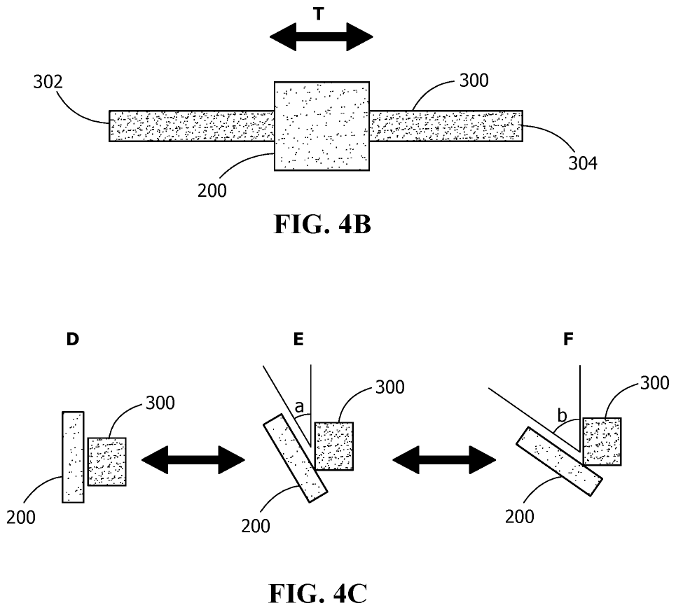

In some implementations, in order to capture sufficient resolution to accurately measure the stock level of a retail shelf, the distance sensor 200 can be further moved (i.e., tilted, rotated, shifted, repositioned, etc.) approximately 0° to 120° to adjust an angle of the emission light signal and its return back to the distance sensor 200, after being reflected. This provides the distance sensor 200 with a greater field of view. As shown in FIG. 4A, the distance sensor 200 can be moved (tilted) to various positions while affixed (i.e., remain stationary) to the bottom surface 129 of shelf 101. For example, position A depicts the distance sensor 200 at its initial position; position B depicts the distance sensor 200 at a position tilted to angle a (e.g., approximately 20°); and position C depicts the distance sensor 200 at a position tilted to angle b (e.g., approximately 45°). It should be appreciated that positions B and C are merely for illustrative purpose, and other angles may be employed.

Referring to FIG. 4B, in some implementations, the distance sensor 200 can move in a translational motion, as indicated by arrow T (e.g., horizontal direction) along a length of the shelf 101 via a linear movement system 300. In other words, the distance sensor 200 can be mounted on the linear movement system 300 and slide along the linear movement system 300 from a first side 302 (i.e., the left side 123) to a second side 304 (i.e., the right side 121), or in an opposite direction, from the second side 304 (i.e., the right side 121) to the first side 302 (i.e., the left side 123). In some implementations, the translational motion T can be made for a portion of the length of the shelf or for the entire length of the shelf. The translational motion T of the distance ensures sufficient resolution to accurately measure the stock level of the entire shelf. Due to the greater resolution, a single sensor may be employed for an entire shelf.

In addition to the translational motion as described above, the distance sensor 200 can further be tilted to capture even greater resolution of the stock level. As shown in FIG. 4C, the distance sensor 200 can be moved (tilted) to various positions while translating along the linear movement system 300. For example, position D depicts the distance sensor 200 at its initial position on the linear movement system 300; position E depicts the distance sensor 200 at a position tilted to angle a (e.g., approximately 20°) with respect to the linear movement system 300; and position F depicts the distance sensor 200 at a position tilted to angle b (e.g., approximately 45°) with respect to the linear movement system 300. It should be appreciated that positions E and F are merely for illustrative purpose and other angles may be employed.

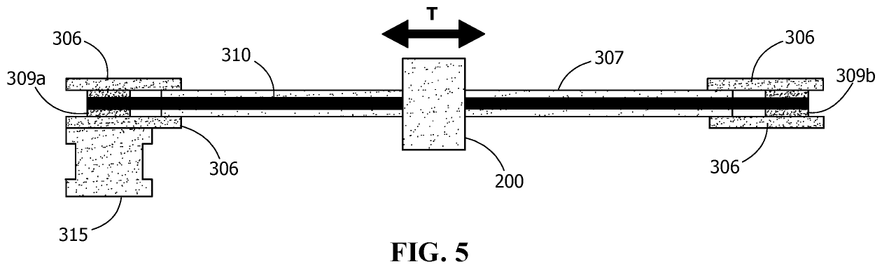

FIG. 5 is a schematic representation of a linear movement system 301 according to an example embodiment of the present disclosure. In some implementations, the linear movement system 301 is mounted underneath the bottom surface 129 of shelf 101 and positioned in-between support structures (e.g., support hooks 131). Because the linear movement system 301 is mounted underneath the shelf 101, it is hidden from plain view and not easily visible to customers walking about the store. The linear movement system 301 is mounted to the shelf 101 using any conventional fastening means, such as, but not limited to, screws, bolts, nuts, nails, anchors, rivets, etc. In other implementations, the linear movement system 301 can be mounted at other areas of the shelving system 100 such as, for example, the (back)wall 102 of the shelving system 100.

In one example embodiment, the linear movement system 301 includes support brackets 306, a support rod 307, pulleys 309a, 309b, a connecting member 310 (e.g., a belt, chain, line, etc.), and a motor 315. The support brackets 306 are positioned near the support hooks 131 of the shelf 101 and holds the support rod 307, a rod, bar or other linear article that spans the length of the shelf over which a particular sensor 200 is designed to operate, which may be a portion or the entire shelf length, along which the distance sensor 200 (typically situated within some form of housing or mount) moves. At their respective ends, the support brackets 306 further hold and support the pulleys 309a, 309b. The connecting member 310 is connected between the (driver) pulley 309a and the (driven) pulley 309b and rotates therebetween. The driver pulley 309a moves the connecting member 310 with respect to the pulleys 309a, 309b. That is, the driver pulley 309a drives the connecting member 310 due to contact between the driver pulley 309a and the connecting member 310. In an example implementation, the connecting member 310 is a rubber belt. However, other connecting means to connect the pulleys 309a, 309b together can be used, such as, for example, a rope, a cable, or the like. The driver pulley 309a is connected to the motor 315 in order to move the connecting member 310 to thereby move the distance sensor 200, as indicated by arrow T. In one example implementation, the motor 315 rotates the driver pulley 309a in either rotational direction (i.e., clockwise and counter-clockwise) and at a constant speed in order to move the distance sensor 200 in a horizontal direction in either directions. In other implementations, the motor 315 can be a variable speed motor to change the speed of movement of the distance sensor 200. Further, the motor 315 can be any type of motor capable of rotating the driver pulley 309a. For example, the motor 315 may be a DC electric motor, such as a stepper motor.

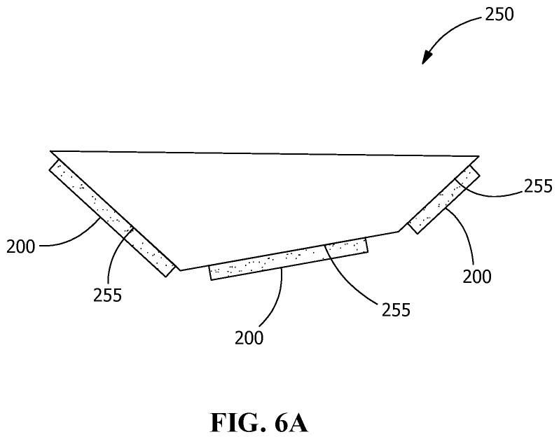

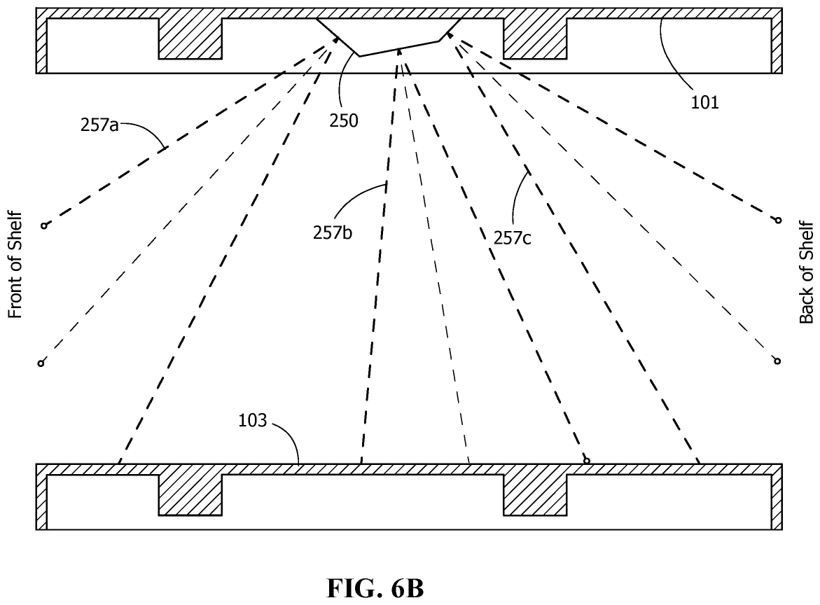

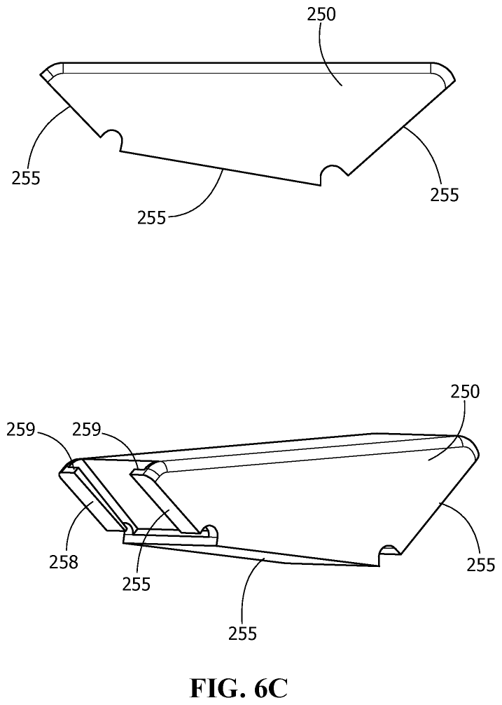

FIGS. 6A-6C are schematic representations of a sensor housing in the form of a multi-sensor holding device 250 holding a plurality of distance sensors 200 according to an example embodiment of the present disclosure. The holding device 250 can be mounted to one (or each) of shelves 101, 103, 105. In an example implementation, the holding device 250 is mounted directly to the back surface 129 of one (or each) of shelves 101, 103, 105, providing a stationary configuration. In other implementations, the holding device 250 can be attached to the linear movement system 300, as discussed above, providing a non-stationary (i.e., mobile, moving, active, etc.) configuration. The holding device 250 should be mounted underneath the shelf to ensure that the distance sensors 200 capture the greatest resolution. For example, the holding device 250 can be mounted towards a center area in a width direction of the shelf underneath. In other words, the holding device 250 can be mounted at a center portion of the right side 121 or the left side 123 of the shelf 101. In other implementations, the holding device 250 can be mounted towards a center portion in a length direction of the shelf. That is, the holding device 250 can be mounted at a center portion of the back side 122 or the front side 124 of the shelf 101. In other implementations, the holding device 250 can be mounted at a center portion of the shelf 101 itself, i.e., between the back side 122 and the front side 125 of shelf 101.

The holding device 250 includes surface portions 255 for holding distance sensors 200, respectively. In one implementation, there may be at least three surface portions 255 for holding three distance sensors 200, respectively. It should further be appreciated that more or less surface portions 255 can be employed to hold the respective distance sensors 200. In this exemplary embodiment, the holding device 250 is substantially triangular shaped. It should be appreciated that other shapes of the holding device 250 may be employed. The surface portions 255 are designed to provide enough resolution to accurately capture the stock level on the shelf. In other words, the distance sensors 200 affixed to the surface portions 255 of the holding device 250 are positioned in such a way that it allows the distance sensors 200 to cover the entire shelf from front to back. To describe differently, the holding device 250 allows for holding a plurality of distance sensors 200 to measure distance values to a predetermined region that represents an entire front to back content of the second shelf located below the first shelf. As shown in FIG. 6B, viewing angles 257a, 257b, 257c (i.e., emission of signals) of respective distance sensors 200 are provided that sufficient coverage of the entire shelf is achieved. For example, viewing angle 257a of respective distance sensor 200 is emitted to cover a front portion of the shelf; viewing angle 257b of respective distance sensor 200 is emitted to cover a central portion of the shelf; and viewing angle 257c of respective distance sensor 200 is emitted to cover a back portion of the shelf. This can permit, for example, the ability to obtain qualitative and/or quantitative information of high stock, mid stock, low stock, and out of stock with respect to a particular item on the shelf based on the number of fields of view in which product is detected.

Referring to FIG. 6C, the holding device 250 includes a connecting mechanism 258, according to an example embodiment. The connecting mechanism 258 can be provided at each surface portion 255 of the holding device 250. The connecting mechanism 258 is configured to hold and secure the respective distance sensors 200 in place in the holding device 250. In one implementation, the connecting mechanism 258 includes a pair of rails 259 that is configured to engage the distance sensor 200 and hold the distance sensor 200 in place. That is, the pair of rails 259 is configured to receive and slidably engage with a corresponding portion of the distance sensor 200. In some implementations, the holding device 250 can include a locking device (not shown) to lock the distance sensor 200 in the connecting mechanism 258.

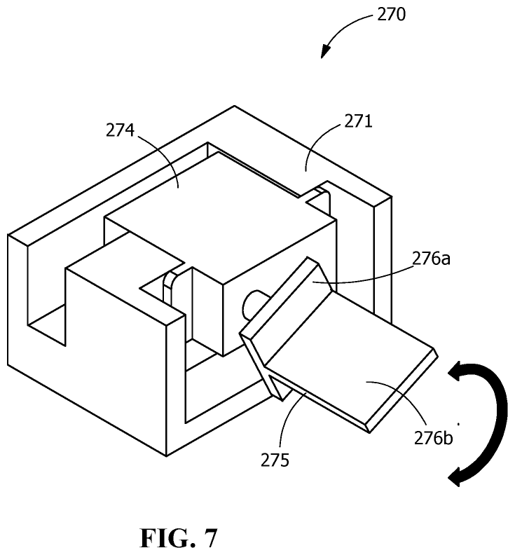

FIG. 7 is a schematic representation of another sensor housing illustrating a sensor holding device 270 for holding a distance sensor (not shown) according to another example embodiment of the present disclosure. As similarly described in FIGS. 6A-6C, the holding device 270 can be mounted to one (or each) of shelves 101, 103, 105. In some implementations, the holding device 270 can be mounted directly to the back surface 129 of one (or each) of shelves 101, 103, 105, providing a stationary configuration, or can be attached to the linear movement system 300, providing a non-stationary configuration. As compared to the example embodiments of FIGS. 6A-6C, the example embodiment of FIG. 7 is configured to hold only one distance sensor 200.

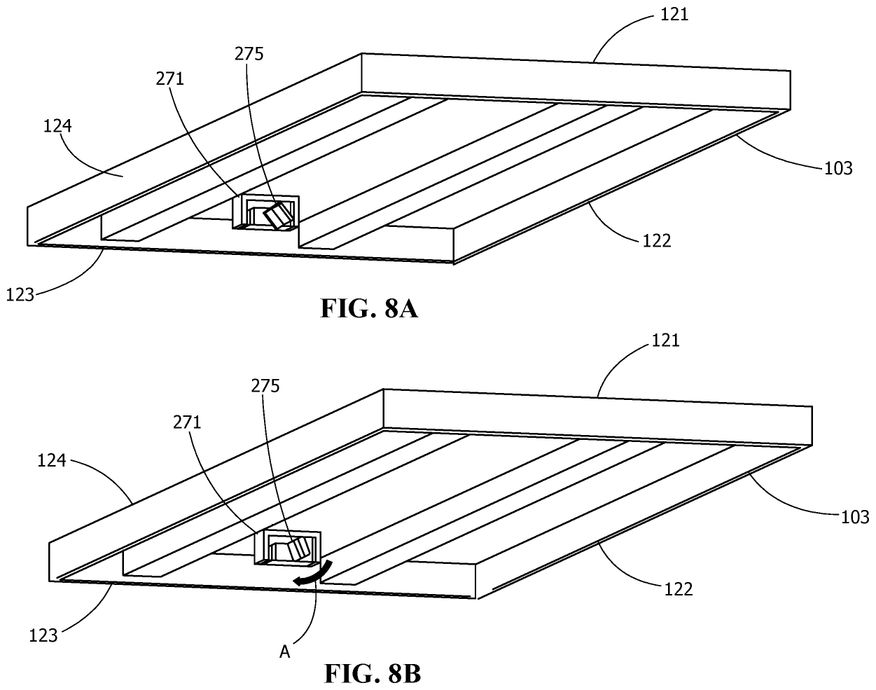

The holding device 270 includes a housing enclosure 271 that houses a motor 274 for moving (i.e., rotating) a sensor platform 275. The housing enclosure 271 is designed to allow for easy mounting to the shelf itself or the linear movement system 300. For example, the housing enclosure 271 is substantially rectangular shaped to engage in the back surface (underneath) the shelf for easy attachment and removal. The housing enclosure 271 is further designed to suppress noise created by components in the enclosure, such as, for example, the motor 274. The motor 274 can be any type of motor capable of rotating the sensor platform 275. In one implementation, the motor 274 may be a DC electric motor, such as a servo motor. The sensor platform 275 is configured to receive and hold the distance sensor 200 that is rotated by the motor 274. In one implementation, the motor 274 rotates the sensor platform 275 up to 180 degrees—allowing the distance sensor 200 to measure distances from front to back of the shelf. In an example implementation, while mounted to the shelf 103 via the housing enclosure 271, the sensor platform 275 is rotated from its initial position (FIG. 8A) facing the back of the shelf to a rotated position (as shown by arrow A) facing the front of the shelf (FIG. 8B). The sensor platform 275 may be rotated incrementally, i.e., temporarily pausing between predetermined fixed positions associated with operation of the sensor at predetermined viewing angles desired to be measured. Alternatively, the sensor platform 275 may be rotated continuously with operation timed to take measured distances.

The sensor platform 275 includes a first portion 276a attached to the motor 274 and a second portion 276b that extends from the first portion 276a for receiving and holding the distance sensor 200. The second portion 276b is designed to engage with a corresponding portion of the distance sensor 200. In some implementations, the second portion 276b may include rails or tracks (not shown) to properly engage with the distance sensor 200. In some implementations, the second portion 276b may include a locking device (not shown) to secure the distance sensor 200 to the second portion 276b of the sensor platform 275.

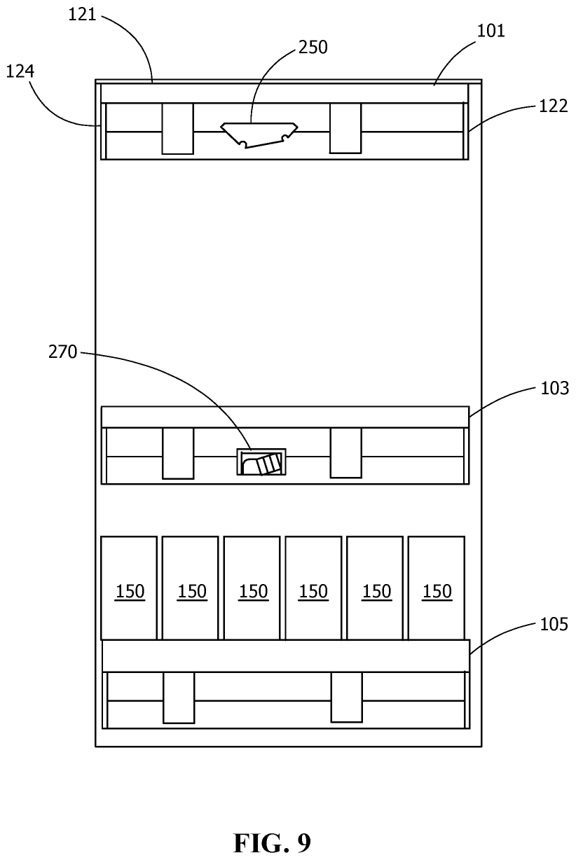

FIG. 9 illustrates another example embodiment in which two holding devices 250 and 270, as discussed above, can be used congruently (i.e., at the same time) with each other. For example, as shown in FIG. 9, which is a view looking towards the right side 121 of shelves 101, 103, the holding device 250 is mounted underneath shelf 101 and the holding device 270 is mounted underneath shelf 103. The holding devices 250 or 270 being used can be associated with the type of items being measured.

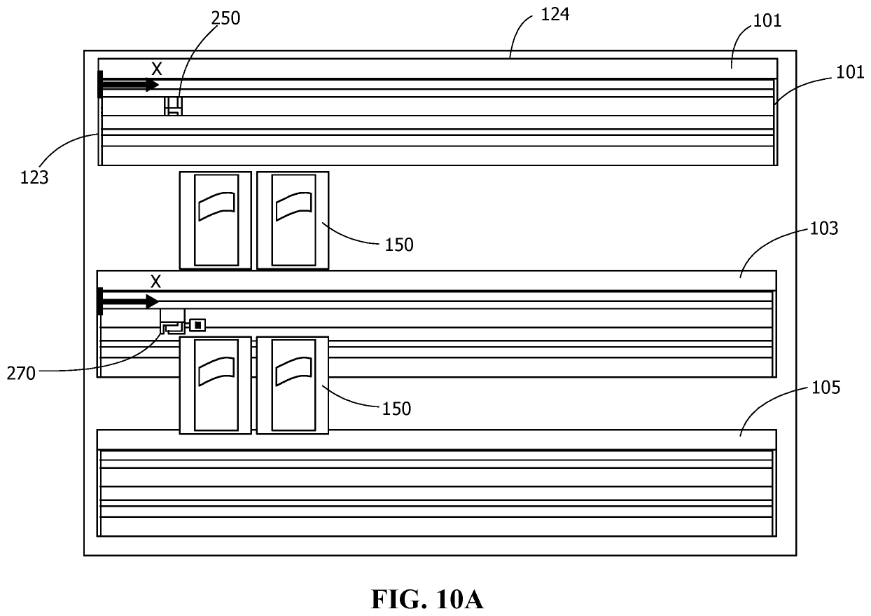

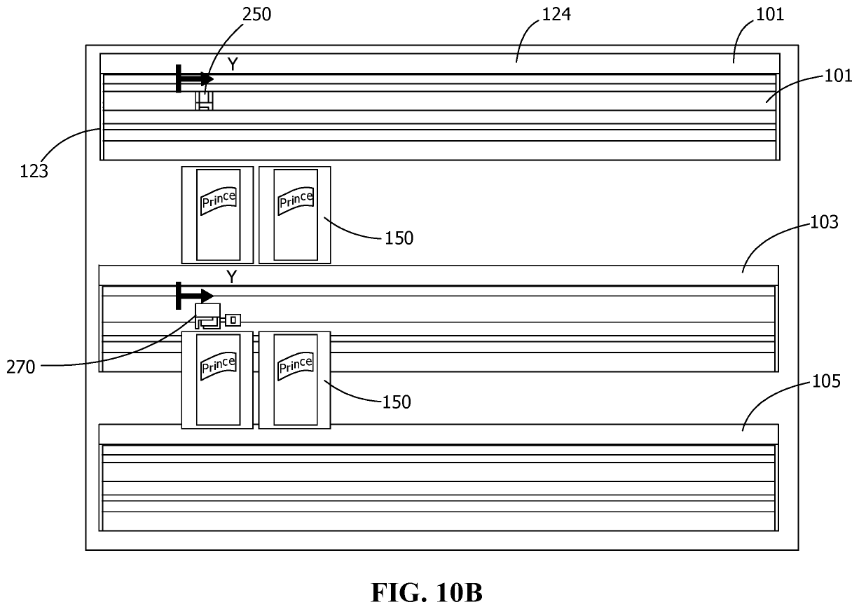

Referring to FIGS. 10A and 10B, in other implementations, the sensor holding devices 250 and 270 can be mounted on the linear movement system 300, causing the sensor holding devices 250 and 270 to translate (i.e., horizontal direction) along the respective shelves 101, 103. FIG. 10A illustrates the holding devices 250 and 270 being moved to position X from its initial position (i.e., near the left side 123 of the shelf 101). FIG. 10B illustrates the holding devices 250 and 270 being moved to position Y from position X, for example, with respect to a predetermined position over a next line of products. As illustrated from a different perspective, the holding device 270 has been moved further in the horizontal direction with respect to the item 150, as shown in FIG. 10B. The translational movement of the holding devices 250 and 270 ensures that sufficient coverage of the entire shelf is achieved via the holding devices 250 and 270 holding the distance sensors 200. In some implementations, the translational movement of the holding devices 250 and 270 can be independent from each other. In other words, the holding device 250 can move to a different position and/or with a different speed than the holding device 270. For example, the holding device 250 can translate further along the horizontal direction (i.e., closer to the right side 121 of the shelf 101) to detect if items 150 are found in shelf 103 while the holding device 270 translates to a different position where items 150 on shelf 105 is located. In another example, the holding device 250 remains stationary (i.e., does not move) at its initial position if the system detects that no items are remaining on the shelf 103; while the holding device 270 translate along the horizontal direction to a different position along the shelf 103. In yet another example, the holding device 250 and the holding device 270 move at different speeds, causing the holding devices 250 and 270 to be at different positions on the respective shelves 101, 103.

Regardless of the particular sensor housing and/or number of sensors employed with the housing, it will likewise be appreciated that the sensor housing may be translated along the length of the shelf incrementally, temporarily pausing for sensor operation at each of one or more predetermined lateral locations associated with a particular product location on the shelf, or via continuous movement, in which, for example, the time to translate across a particular product location on the shelf permits sensor operation to still poll the viewing angles needed to determine the amount of stock.

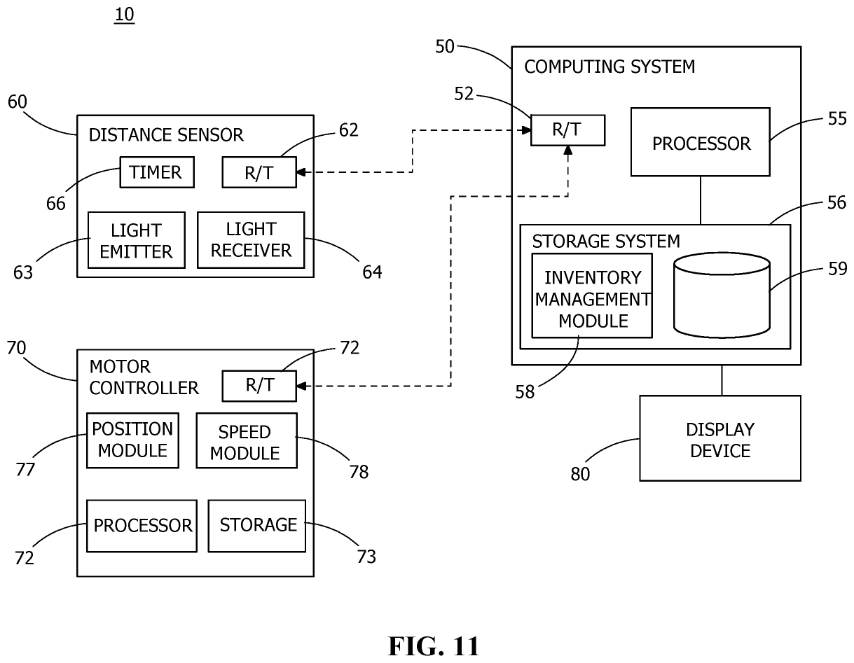

FIG. 11 is a schematic representation of an exemplary inventory management system 10, according to an example embodiment of the present disclosure. The inventory management system includes a computing system 50 in communication with a distance sensor 60 and a motor controller 70. The computer system 50 receives information collected by the distance sensor 50 via a receiver/transmitter 52. The receiver/transmitter 52 is configured to receive information measured by the distance sensor 60 from a receiver/transmitter 62 of the distance sensor 65. The receiver/transmitters 52 and 62 may communicate by any wireless communication protocols or means, such as Bluetooth, Wi-Fi, RF transmission, GPS, ZigBee, Z-Wave, or the like. The motor controller may also include a separate receiver/transmitter 72 for communication with the computing system 50, which may be a different wireless protocol than communication with the receiver/transmitters 52 and/or 62. In other implementations, the inventory management system may include only one receiver/transmitter to handle all communications between the distance sensor 60, the motor controller 70, and the computing system 50. In other implementations, the computing system 10 may be hardwired to the distance sensor 60 and/or the motor controller 70. For example, the computing system 10 may be communicating over a serial connection (e.g., I2C interface) with the distance sensor 60 and/or motor controller 70. In other implementations, the computing system 10 performs data processing and communicates information using a wireless communication protocol to a storage system. The storage system may be implemented as a single storage device, but may also be implemented across multiple storage devices or subsystems located at disparate locations and communicatively connected, such as in a cloud computing system.

The distance sensor 60 is configured to measure a distance L measured at each inventory location. One exemplary embodiment of a distance sensor is a Time of Flight (ToF) sensor using laser scanners to measure a depth of various points in an image with infrared light, for example. This depth can be associated as the measured distance L, which can be measured from the distance sensor 60 to a surface of an underneath shelf or to a specific item. As defined herein, the measured distance L can include a distance of the distance sensor 60 having a thickness that is part of that measured distance. The distance sensor 60 includes a light emitter 63 that produces the light to bounce off a targeted item and returned to a light receiver 64. Based on a time difference, via a timer 66, between the emission of the light and its return to the light receiver 64 after being reflected by the targeted item, the distance sensor 60 is able to measure the distance L between the target item and the distance sensor 60. In some implementations, the distance sensor 60 uses travel-time to determine distance (or depth), such as, for example, time pulses or phase shift of an amplitude modulated wave. This measured distance L is then communicated to the computing system 50 to be process, which will be described herein.

The computing system 50 provides control instructions to be executed by the motor controller 60 which controls a motor driving a linear movement system or a motor driving a sensor housing that holds the distance sensor(s). The control instructions may be individually configured for each plane. That is, the control instructions may identify, for example, a single axis (i.e., a horizontal coordinate) within a two-dimensional scanning plane where the distance sensor 60 is to be placed in order to be aligned with and scan a series of inventory locations on the shelf. In other implementations, the control instructions may identify scanning positions on a two-axis system (i.e., XY coordinate). The control instructions may further provide instructions to a position module 77 and a speed module 78 of the motor controller 60. The position module 77 determines a position(s) of the distance sensor 60 to translate along the length (i.e., horizontal direction) of the shelf, which may be incrementally for sensor operation at each of one or more predetermined lateral locations associated with a particular product location on the shelf, or via continuous movement. The speed module 78 determines the speed of the distance sensor 60 to translate along the length of the shelf. In other implementation, the speed module 78 can determine a variable speed or a constant speed.

The motor controller 70 includes a processing system 72 and a storage 73. The storage 73 may house software, such as control software to execute control instructions for managing the linear movement system and/or the sensor housing. For example, the control functionality of the motor controller 70 may be programmable, such as programmable via the computing system 50. Control software stored in the storage 73 of the motor controller 70 is executable by the processor 72 in order to carry out certain aspects of the inventory management methods and system controls described herein.

The computing system 50 includes a processor 55 and a storage system 56. The storage system 56 includes software, including inventory management module 58, and stored data 59, including data in database structure. The processor 55 loads and executes software, including the inventory management module 58, which is a software application stored in the storage system 56. The processor 55 can also access data stored in the database 59 in order to carry out the methods and control instructions described herein. Although the computing system 50 is depicted in FIG. 11 as one unitary system encapsulating one processor 55 and one storage system 56, it should be appreciated that one or more storage systems 56 and one or more processors 55, may comprise the computing system 50, which may be a cloud computing application and system. Similarly, while the inventory management module 58 is schematically depicted as a single software application contained on a single storage system 56, it is to be recognized that the inventory management module 58 may be implemented as various software instruction sets, or modules, stored at various locations, such as on various storage systems. The processor 55 includes a processor, which may be a microprocessor, a general-purpose central processing unit, an application-specific processor, a microcontroller, or any type of logic device. The processor 55 may also include circuitry for retrieving and executing software, including the inventory management module 58, from the storage system 56. The processor 55 may be implemented with a single processing device, but may also be distributed across multiple processing devices or subsystems that cooperate in executing software instructions.

The storage system 56, which stores database 59, may comprise any storage media, or group of storage media, readable by processor 55, and capable of storing software and data. The storage system 56 can include volatile and non-volatile, removable and non-removable media implemented in any method or technology for storage of information, such as computer-readable instructions, data structures, program modules, or other data. As described above, storage system 56 may be implemented as a single storage device, but may also be implemented across multiple storage devices or subsystems located at disparate locations and communicatively connected, such as in a cloud computing system. Examples of storage media include random access memory, read only memory, optical discs, flash memory, virtual memory, and non-virtual memory, or any other medium which can be used to store the desired information and may be accessed by a processor 55.

The inventory management module 58 operates to control and produce the functionality of the inventory management system 10. For example, the inventory management module 58 determines an inventory amount based on the distance measured by the distance sensor 60 in conjunction with analyzing information about sensor position along the length of the shelf with respect to planogram information. Additionally, the inventory management module 58 may function to track any of a variety of inventory management and system parameters, and to provide information to a user regarding those aspects. For example, the inventory management module 58 may provide real time results measured during the inventory scanning process, may provide inventory notifications regarding low inventory or out-of-stock inventory based on per item basis, and/or may provide planogram compliance information. Alternatively or additionally, the inventory management module 58 may access control instructions to a linear movement system, as described herein, and may transmit such program instructions from receiver/transmitter 52 to the motor controller 70 for execution. Accordingly, the inventory management module 58 may determine when a scanning exercise should occur. For example, the inventory management module 58 may instruct scanning the inventory locations in a scanning plane once an inventory item has been removed from a shelf. For example, the system may include the distance sensor that measures a distance from the distance sensor to items on the shelf, and once an item is removed, the system scans the inventory locations for actual item inventory. Alternatively or additionally, the inventory management module 58 may instruct periodic scanning of the scanning plane. For example, the periodic scanning can occur at any interval, such as, minutes, 1 hour, 8 hours, 12 hours, 24 hours, etc.

The inventory management module 58 determines the item amount based on the distance L measured at each inventory location. Depending on the arrangement of the inventory location, the inventory management module 58 determines the item amount based on a type of item contained at the inventory location, which may be a specific item or may be determined based on a planogram for the scanning plane 12. For example, the inventory management module 58 may have information regarding the dimensions of various identified items or item types, such as item dimensions. Accordingly, the distance L measured by the distance sensor 60 can be calculated by a corresponding dimension/size of the item, i.e., the depth on the item occupying the location, to arrive at the item amount.

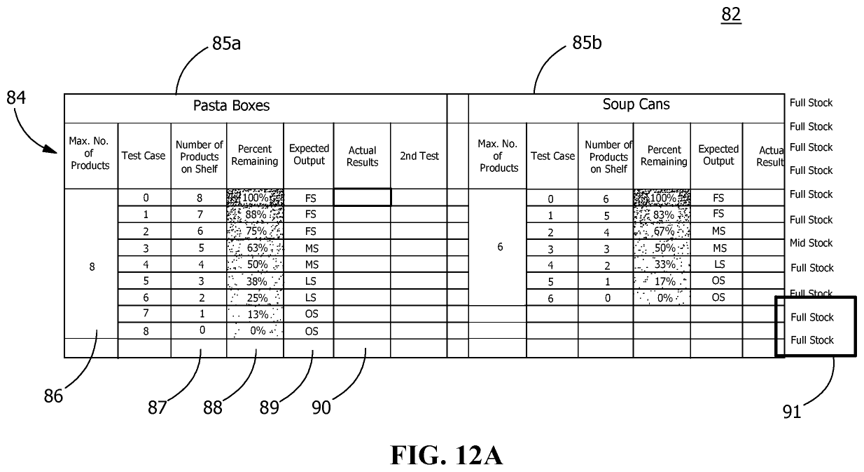

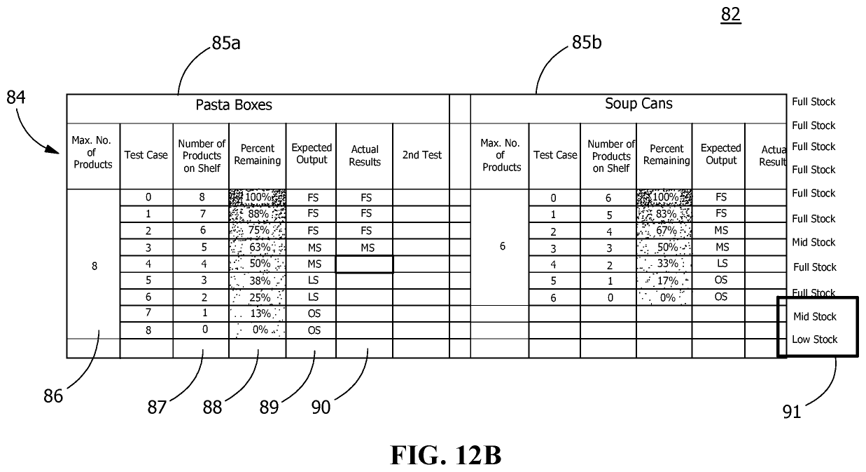

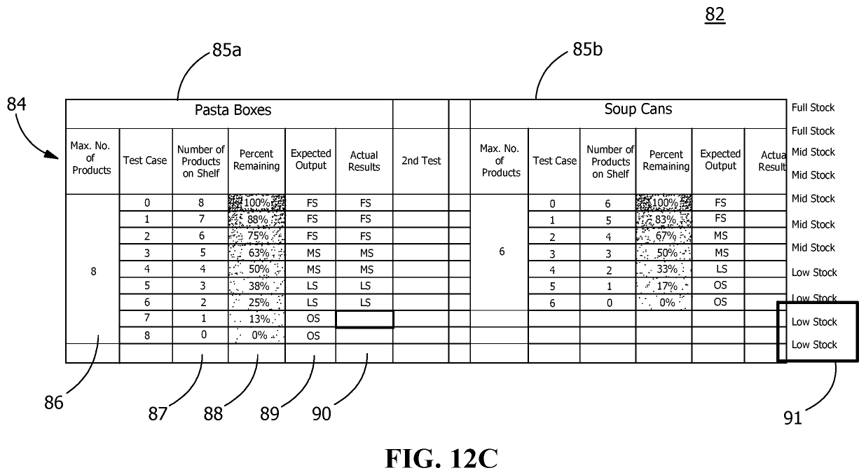

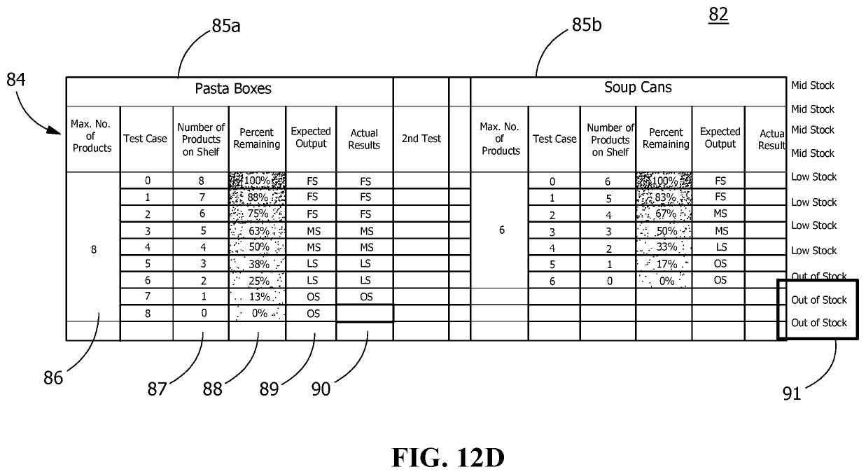

Further, the computing system 50 includes a display device 80 in communication to display the information executed by the inventory management module 58. The display device 80 may be a display on a device, such as a computer monitor, a laptop, a television, a smart phone, etc. FIGS. 12A-12D illustrate one embodiment of a display 82 on the display device 80 that was generated by the scanning process. In one implementation, the display 82 displays a table 84 providing a series of inventory items 85a, 85b, where each inventory item 85a, 85b represents an inventory location in the shelf. For illustrative purpose, the series of inventory items 85a is pasta boxes and the series of inventory items 85b is soup cans, for example.

The table 84 further includes a maximum number of items indicator 86 to be tested, a number of items on shelf indicator 87 to indicate an amount of items allotted on the shelf, a percent remaining indicator 88 to indicate a percentage of items remaining on the shelf, an expected output indicator 89 to indicate an expected stock level of the items on the shelf, and an actual result indicator 90 to indicate an actual amount of stock level on the shelf. The item amount for each location may be displayed at the respective table location 84 so that the inventory across a scanning plane may be assessed, such as for stocking purposes. In addition to indicating the actual item amount, a low stock or out-of-stock indicator is provided to alert a user where the item amount is below a low inventory threshold, such as indicating that the items at that inventory location needs to be restocked. It should be appreciated that inventory item 85b also includes similar indicators as related to inventory item 85a and will not be repeated herein.

Similarly, the item amount or inventory threshold may be determined based on the distance L, such as by comparing the measured distance L to a distance threshold, such as a maximum distance value representing low inventory. Referring to the exemplary display 82 at FIGS. 12A-12D, a percentage of higher than 75% of stock remaining indicates a full (or near) stock, a percentage of below 63% of stock remaining indicates a mid-stock level, a percentage of below 38% of stock remaining indicates a low stock level, and a percentage of below 11% of stock remaining indicates an out-of-stock level.

In some implementations, a stock level indication may be a visual alert provided at the percent remaining indicator 87. For example, the visual alert can be a color indicator that indicates an out-of-stock inventory level, with a red mark indicating out-of-stock, a very low inventory level, with an orange mark indicating low stock level, a mid-stock inventory level, with a yellow mark indicating a mid-stock level, and a full stock inventory level, with a green mark indicating full stock. It should be appreciated to represent the different color indicators, FIGS. 12A-12D illustrate the different stock levels using shading effect.

Various other embodiments of visual or other alerts are provided in the display 82. For example, indicator 91, displayed at a lower right of the display 82, indicates the current stock level in conjunction with the actual result indicator 90 indicating the current stock level, (e.g., full stock (FS), mid-stock (MS), low stock (LS), and out-of-stock (OS)). For example, FIG. 12A depicts the inventory level at full stock when more than 75% of items remain on the shelf (also indicated by FS in indicator 89); FIG. 12B depicts the inventory level at mid-stock when less than 63% of items remain on the shelf (also indicated by MS in indicator 89); FIG. 12C depicts the inventory level at low-stock when less than 33% of items remain on the shelf (also indicated by LS in indicator 89); and FIG. 12D depicts the inventory level at out-of-stock when less than 13% of items remain on the shelf (also indicated by OS in indicator 89).

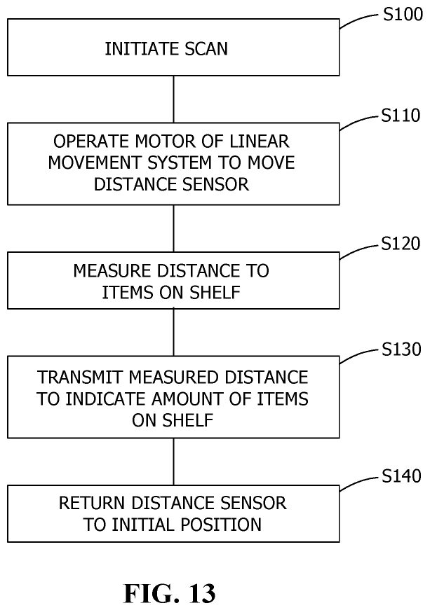

FIG. 13 is a flowchart of a method, or portions thereof, of assessing current inventory provided in a display, according to an example embodiment. In step S100, a scanning process is initiated, such as executed by the distance sensor 60 and the motor controller 70, which may be in further coordination with the inventory management module 58. In one implementation, the scanning process may be initiated when an item is removed from the shelf. Once the scanning process is initiated, the motor of the linear movement system is operated at step S110, resulting from instructions by the motor controller 70, to move the distance sensor 60 to a position with an inventory location in the shelf. The distance sensor 60 may be translated along the length of the shelf incrementally, temporarily pausing for sensor operation at each of one or more predetermined lateral locations associated with a particular product location on the shelf, or via continuous movement, in which, for example, the time to translate across a particular product location on the shelf permits sensor operation to still poll the viewing angles needed to determine the amount of stock.

Next, the distance sensor 60 measures various measurements at step S120, including measuring the distance L to the item(s). For example, the measured distance L can be from the distance sensor 60 to a surface of an underneath shelf (including the distance of the distance sensor 60 itself). At step S130, the measured distance L is transmitted to the computing system 50. In other implementations, the measurements may be stored at a memory on the distance sensor 60, and upon completion of a scanning process across a scanning axis or plane, all measurements may be transmitted to the computing system 50. Next, the inventory management system determines whether the inventory location on a scanning axis or in a scanning plane has been reached, or whether scanning should continue. Once all inventory locations have been scanned or scanning no longer commences, the distance sensor 60 returns to its initial position at step S140. Any stored data that was not transmitted is then communicated to the computing system 50.

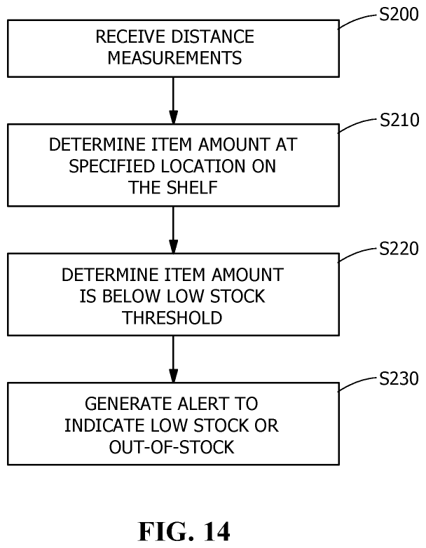

FIG. 14 is a flowchart of a method of assessing an inventory assessment based on the measured data, according to an example embodiment. These steps may be executed, for example, by the inventory management module 58, which may be on the computing system 50. In step S200, the distance measurement is received by the inventory management module 58 based on the distance sensor's lateral movement along the length of the shelf associated with a particular product location on the shelf. The measurement from the inventory location where the items are located is then assessed.

Based on the received distance measurement (or depth of the item on the shelf), the inventory management module 58 can identify an amount of items remaining on the shelf based on a per item basis. The measured distance can also be described as the amount of space occupied by the items on the shelf. For example, the distance may be determined based on a distance between the distance sensor and an edge of the location, such as a front end of the shelf. The inventory amount at the inventory location is then determined at step S220 based on the measured distance. Then, at step S230, if the stock level of inventory falls below a threshold, an alert is generated to indicate that items on the location of the shelf is low or out-of-stock. For example, a percentage of remaining items remaining can be displayed or a visual alert having a color indicator to indicate a low stock or an out-of-stock inventory level is displayed (e.g., color red or orange).

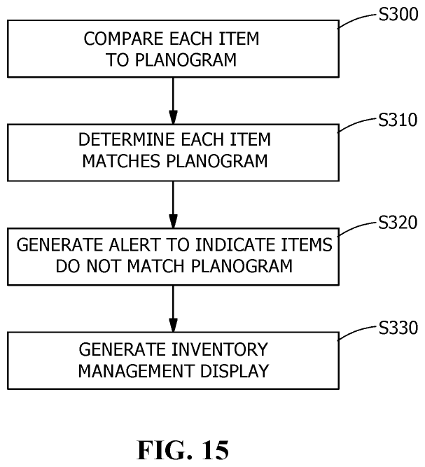

FIG. 15 is a flowchart of a method of assessing an inventory assessment based on the measured data, according to an example embodiment. Another function of the inventory management module 58 may be planogram compliance monitoring. For example, the inventory management module 58 may receive a planogram for each scanning plane to ascertain the stock levels by comparing data regarding the sensor position along the shelf to planogram information. In step S300, the item at each inventory location is compared to the item identified at the respective planogram location to determine whether the correct item is in that inventory location at step S310. If not, an alert may be provided to check the inventory at the respective inventory location at step S320. In some implementations, the planogram compliance value may include a compliance indicator for each inventory location, such as a positive or negative value indicating a match or mismatch between the item identification and the planogram. Additionally, the inventory management module 58 may track statistical planogram compliance value(s), such as a percentage of compliance between the item identification at all inventory locations and the corresponding planogram(s), an average compliance over time, or compliance percent for a particular product or brand of products. This provides valuable information to product owners and vendors regarding whether or not a planogram is being followed in a particular retail environment. Also, in this effect, the collected data about the location of items on a shelf provides predictions of stock level on a per product basis, and not on a per shelf basis

In some implementations, the inventory management system may include a tag reader that reads a tag associated with each item. The tag provides an item identification identifying a retail item housed at the inventory location. In various examples, the item identification may be a general identification of the type of retail item (e.g., 16 oz pasta box, 8 oz can soup, small bag of chips, etc.). In one implementation, the tag reader may be a near field communication (NFC) reader and the tag may be an NFC tag. In other implementations, the tag reader may be any type of device capable of reading the associated tag. For example, the tag may be a barcode, QR code, or other visual code depiction, and the tag reader may be a corresponding barcode scanner or QR code scanner or imaging device. The tag is arranged at a location so as to be readable by the tag reader when the distance sensor is at the inventory location. In some implementations, the tag can be fixed to the back wall of the shelf and positioned such that the tag reader is in very close proximity to the tag.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of and” “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. An inventory detection system, comprising:
a sensor module disposed on a first shelf, wherein the first shelf includes a top surface and a bottom surface opposite the top surface, the sensor module includes a distance sensor to measure a distance value to an item at an inventory location on a second shelf located below the first shelf;
a linear movement system mounted to the bottom surface of the first shelf, the linear movement system being configured to translate the sensor module along a horizontal direction of the first shelf so as to acquire the measured distance value; and
a control unit configured to control the linear movement of the sensor module and collect data associated with the measured distance value,
wherein the control unit is configured to determine items remaining on the second shelf based on a comparison of the measured distance value to a distance threshold to define an inventory assessment system, wherein the distance value is measured from a top surface of the second shelf to the bottom surface of the first shelf.

2. The system of claim 1, wherein the distance value is measured from the item to the bottom surface of the first shelf.

3. The system of claim 1, wherein the sensor module comprises a holder for holding a plurality of distance sensors to measure distance values to a predetermined region that represents an entire front to back content of the second shelf located below the sensor module, the plurality of distance sensors being affixed at predetermined angles defined by angled surfaces of the holder.

4. The system of claim 3, wherein the holder has three sides for receiving the respective distance sensor, wherein each side is angled with respect to each other.

5. The system of claim 3, wherein a first distance sensor is disposed on a first side of the holder and configured to detect an item in a first area of the second shelf,
wherein a second distance sensor is disposed on a second side of the holder and configured to detect an item in a second area of the second shelf,
wherein a third distance sensor is disposed on a third side of the holder and configured to detect an item in a third area of the second shelf, and
wherein the first area, the second area and the third area are different areas of the second shelf.

6. The system of claim 3, wherein the control unit is configured to operate the linear movement system in conjunction with the holder that holds the plurality of distance sensors to acquire an accurate measured distance value.

7. The system of claim 1, wherein the sensor module includes a movable platform to receive the distance sensor, wherein the movable platform is configured to rotate via a second motor.

8. The system of claim 7, wherein the movable platform is configured to rotate 180 degrees.

9. The system of claim 7, wherein the control unit is configured to operate the linear movement system in conjunction with the moveable platform containing the distance sensor to acquire an accurate measured distance value.

10. The system of claim 1, wherein the linear movement system comprises:
a pair of supports positioned near respective ends of the first shelf;
a support rod, disposed between the pair of supports, that spans in the horizontal length of the first shelf over which the distance sensor is designed to operate thereon;
a driver pulley and a driven pulley supported by the pair of supports;
a connecting member connected between the driver pulley and the driven pulley and configured to rotate therebetween; and
a motor configured to operate the driver pulley.

11. The system of claim 10, wherein the motor rotates the driver pulley in rotational directions resulting in moving the distance sensor in the horizontal length in either direction.

12. The system of claim 10, wherein the motor is a servo motor.

13. The system of claim 10, wherein the connecting member is at least one of a belt, a chain, a cable, a rope, or a line.

14. A method of assessing inventory in a shelving unit, comprising:
measuring, by a sensor module, a distance value to an item at an inventory location on a first shelf, wherein the sensor module is disposed on a second shelf, which is above the first shelf;
translating, via a linear movement system, the sensor module along a horizontal direction of the second shelf so as to acquire the measured distance value, wherein the linear movement system is mounted to a bottom surface of the second shelf;
controlling, via a control unit, the linear movement of the sensor module to collect data associated with the measured distance value; and
determining, by the control unit, items remaining on the first shelf based on a comparison of the measured distance value to a distance threshold to define an inventory assessment.

15. The method of claim 14, wherein measuring the distance value includes measuring from a bottom surface of the second shelf to a top surface of the first shelf.

16. The method of claim 14, further comprising measuring, by a plurality of distance sensors, distance values of an entire area of the first shelf, wherein the plurality of distance sensors are affixed at predetermined angles defined by angled surfaces of a holder.

17. The method of claim 16, further comprising operating the linear movement system in conjunction with the holder that holds the plurality of distance sensors to acquire the measured distance value.

18. The method of claim 16, further comprising a first distance sensor disposed on a first side of the holder and configured to detect an item in a first area of the second shelf, a second distance sensor disposed on a second side of the holder and configured to detect an item in a second area of the second shelf, a third distance sensor disposed on a third side of the holder and configured to detect an item in a third area of the second shelf, wherein the first area, the second area and the third area are different areas of the second shelf.

19. The method of claim 14, further comprising rotating, by a rotating platform, the sensor module.

20. The method of claim 19, further comprising operating the linear movement system in conjunction with the rotating platform to acquire the measured distance value.
